(19) United States
(12) Patent Application Publication
(10) Pub. No.: US 2019/0369679 A1
(43) Pub. Date: Dec. 5, 2019

(54) Adjustable Computer Hardware Case

(71) Applicant: Riotoro Inc., Union City, CA (US)

(72) Inventor: Luis Alvarenga, Pembroke Pines, FL (US)

(73) Assignee: Riotoro Inc., Union City, CA (US)

(21) Appl. No.: 16/352,496

(22) Filed: Mar. 13, 2019

(30) Foreign Application Priority Data
May 30, 2018 (CN) 201810540541.1

(51) Int. Cl. G06F 1/18

(52) U.S. Cl. CPC G06F 1/181

(57) ABSTRACT

An adjustable computer hardware case having a top plate, a bottom plate, a front plate assembly, a rear plate assembly, two side plate assemblies, and an inner frame. The front, rear, and side plate assemblies include a first panel and a second panel, wherein the first panels are fastened to respective second panels and are vertically adjustably thereto. Thus, the height adjustment of the adjustable computer hardware case is implemented to change the hardware case to various sizes. The adjustable assembly design can be provided to end users to assemble a hardware case product of the required size and give the end user a better user experience.

### CROSS-REFERENCE TO RELATED APPLICATION

This application claims priority from Chinese Patent Application No. 201810540541.1 filed on May 30, 2018, the disclosure of which is hereby incorporated by reference.

### FIELD

The present disclosure relates to computer hardware cases, and more particularly to a computer hardware case that is adjustable to multiple sizes in order to accommodate different size computers or combinations of computer hardware components.

### BACKGROUND

Computer hardware cases house and secure various computer accessories and components, such as a power supply, motherboard, fans, expansion boards, input/output panels etc. The hardware case supports and protects these and other important hardware components.

The problem with currently existing computer cases is that they are a fixed size, and cannot be re-sized. The result is that due to the variety of sizes and shapes of hardware components, typical computer cases only fit a few computer models. A fixed-size hardware case also limits customizability. An effective alternate is required.

### SUMMARY

In view of the lack of existing technology, a purpose of the adjustable computer hardware case of the present disclosure is to provide a telescopically adjustable hardware case or chassis, which utilizes height adjustment to alter the design and shape of the hardware case. Additionally, the computer case of the present disclosure is easily adjustable by the end user. In one embodiment, the adjustable computer case has two configurations, standard and extended. However, other embodiments may have more than two configurations.

The height of the adjustable computer hardware case can be changed by using an adjustable front plate assembly, an adjustable rear plate assembly, and two adjustable side plate assemblies. Optionally, these parts can be provided to the end users, allowing them to assemble their own hardware case of their desired size and dimensions.

In one embodiment of the adjustable computer hardware case, the hardware case includes a top plate, a bottom plate, a front plate assembly, a rear plate assembly, and opposing side plate assemblies. The front plate assembly, the rear plate assembly, and the opposing side plate assemblies are further comprised of upper panels and lower panels. Each upper and lower panel has multiple connection positions allowing the upper panels to be affixed at differing heights to the respective lower panel so that the overall height of the hardware case can be adjusted depending upon the relative connection positions of the respective upper and lower panels of each front, back, and side assembly.

In another embodiment of the adjustable computer hardware case, the hardware case is comprised of a top plate, a bottom plate, an adjustable front plate assembly, an adjustable rear plate assembly, and two adjustable side plate assemblies.

The adjustable front plate assembly is formed by a first front panel and a second front panel that are vertically adjustable relative to each other. The adjustable rear plate assembly is formed by a first rear panel and a second rear panel that are vertically adjustable relative to each other. The two adjustable side plate assemblies are formed by first side panels and second side panels that are vertically adjustable relative to each other. The computer hardware case is formed by assembling and affixing each of the plate assemblies and the top and bottom plates. When constructed, the adjustable front plate assembly is situated between left and right ends of the two adjustable side plate assemblies, the adjustable rear plate assembly is situated between opposite ends of the two adjustable side plate assemblies, the top plate is situated between tops of the front, rear, and side plate assemblies, and the bottom plate is situated between bottoms of the front, rear, and side plate assemblies. The overall height of the constructed hardware case is controlled by the vertically adjustable relationship between the respective first and second panels.

In another embodiment, a method of adjusting the dimensions of a computer hardware case is provided. The method includes providing a front assembly, a rear assembly, and opposing side assemblies, where each assembly is further comprised of a top panel and a bottom panel. Each top panel has at least two sets of connecting holes and each bottom panel has at least two sets of corresponding holes. The hardware case is formed by aligning one set of connecting holes of a top panel with one set of corresponding holes of a respective bottom panel securing the set of connecting holes with the aligned set of corresponding holes to maintain the panels in their adjusted configuration.

### BRIEF DESCRIPTION OF THE DRAWINGS

FIG. 1 illustrates a front perspective view of the adjustable computer hardware case of the present disclosure;

FIG. 2 illustrates a rear perspective view thereof also including the optional magnetic filter;

FIG. 3 illustrates a front view of an expanded configuration of the adjustable computer hardware case of the present disclosure;

FIG. 4 illustrates a front view of a standard configuration of the adjustable computer hardware case of the present disclosure;

FIG. 5 illustrates a front exploded view of the front plate assembly;

FIG. 6 illustrates a rear exploded view of the front plate assembly;

FIG. 7 illustrates a front exploded view of the rear plate assembly;

FIG. 8 illustrates a rear exploded view of the rear plate assembly;

FIG. 9 illustrates a perspective view of the side plate assembly;

FIG. 10 illustrates an exploded view of the side plate assembly;

FIG. 11 illustrates a side view of the inner frame; and

FIG. 12 illustrates an exploded view of the inner frame.

### DETAILED DESCRIPTION

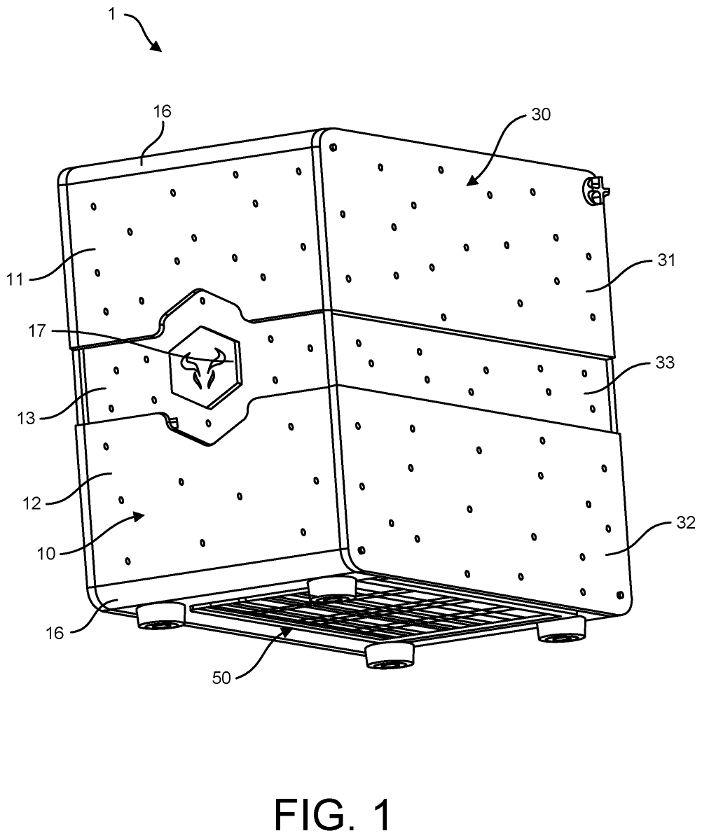

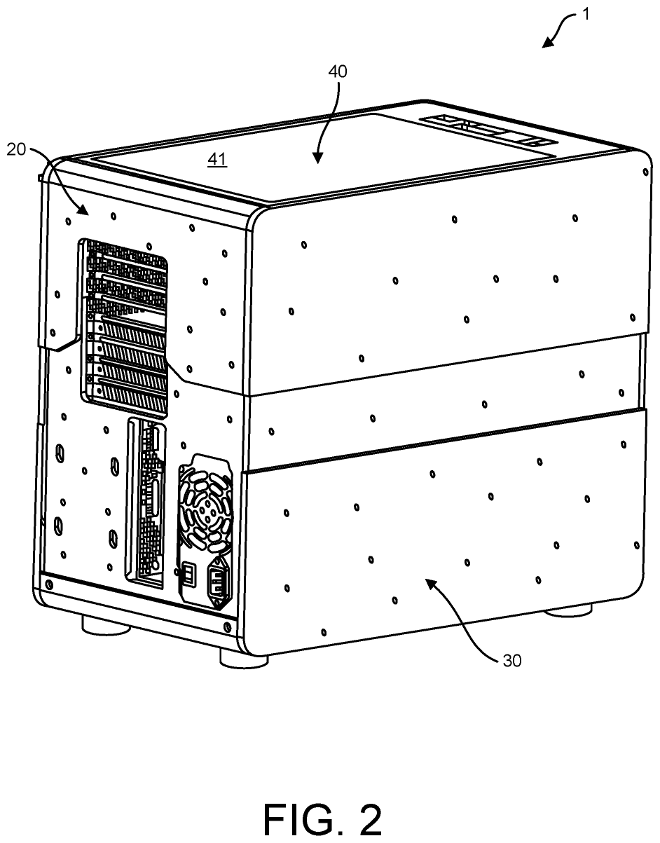

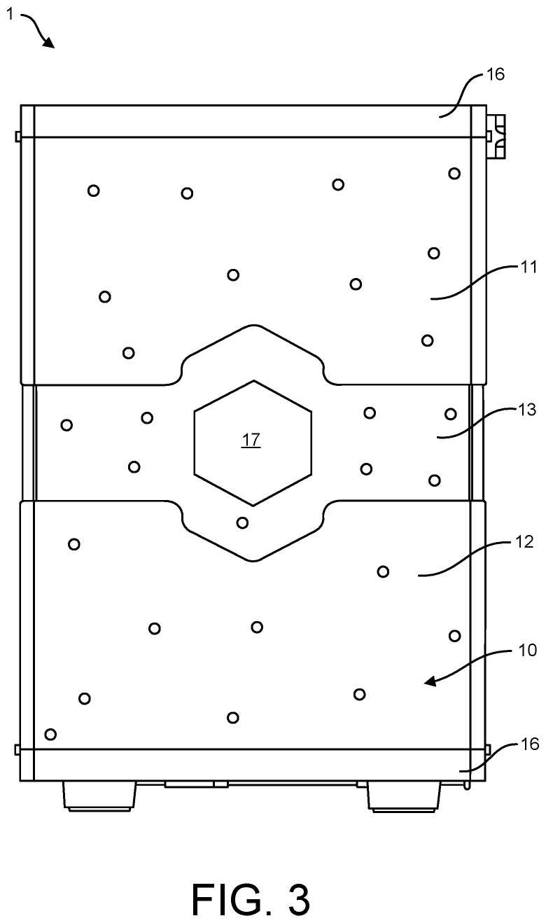

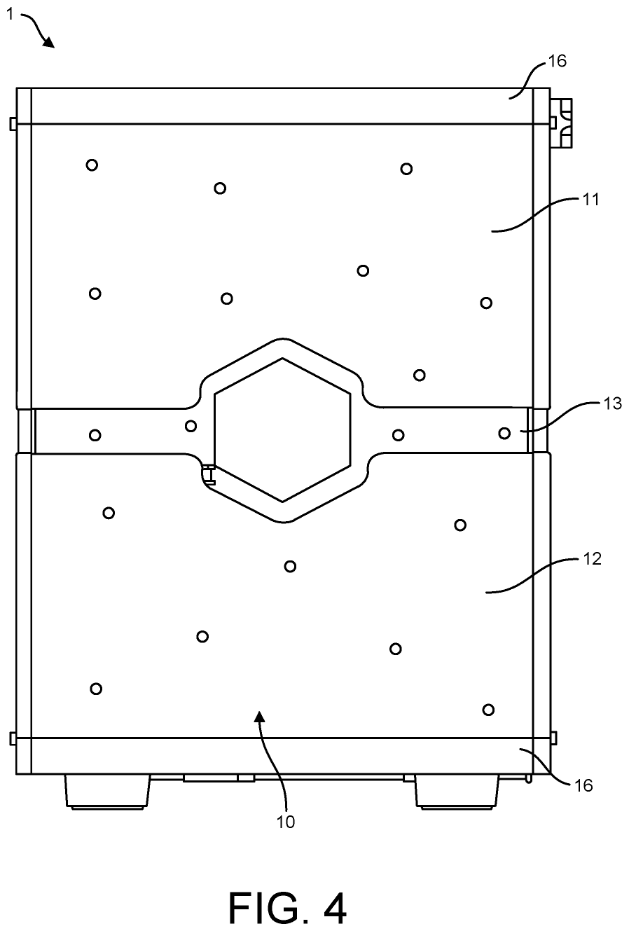

The adjustable computer hardware case 1 of the present disclosure, shown in FIGS. 1 through 12, includes a telescopic adjustable chassis, comprising a top plate 40 (shown in FIG. 2), a bottom plate 50, a front plate assembly 10, a rear plate assembly 20 (shown in FIG. 2), and two side plate assemblies 30.

Now referring to FIGS. 1 through 4, the front plate assembly 10 is coupled between the front ends of the two side plate assemblies 30. The rear plate assembly 20 is connected to and between the back ends of the two side plate assemblies 30. The top plate 40 is connected to top ends of the front plate assembly 10, the rear plate assembly 20, and the two side plate assemblies 30. The bottom plate 50 is connected to bottom ends of the front plate assembly 10, the rear plate assembly 20, and the two side plate assemblies 30.

The front plate assembly 10 is further comprised of a first front panel 11, a second front panel 12, and a front connecting plate 13 situated therebetween, as shown in FIG. 1. Each side plate assembly 30 is further comprised of a first side panel 31, a second side panel 32, and a side connecting plate 33 situated therebetween, as shown in FIG. 1.

In one embodiment, arcuate transition plates 16 are mounted at the corners where the front plate assembly 10 or rear plate assembly 20 meets the top plate 40 or bottom plate 50.

As shown in FIG. 2, in one embodiment, a magnetic filter 41 is included on the top plate 40. However, the magnetic filter 41 may be located on any of the sides of the computer hardware case 1. And the computer hardware case 1 may include more than one magnetic filter 41.

In FIGS. 1 through 6, the computer hardware case 1 is shown with optional detachable LED logo 17. In some embodiments, the detachable LED logo 17 is modular allowing for various shapes or designs. The detachable LED logo 17 may be located on any side of the computer hardware case 1.

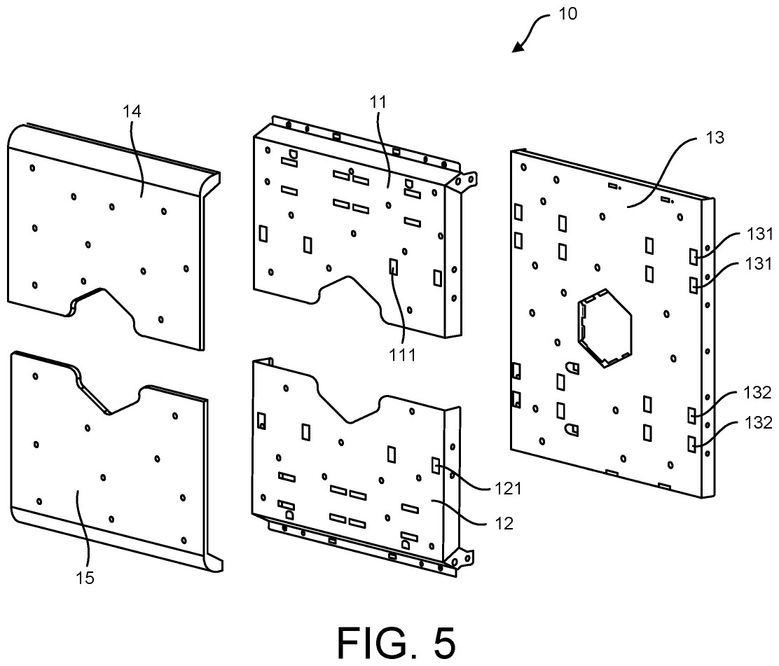

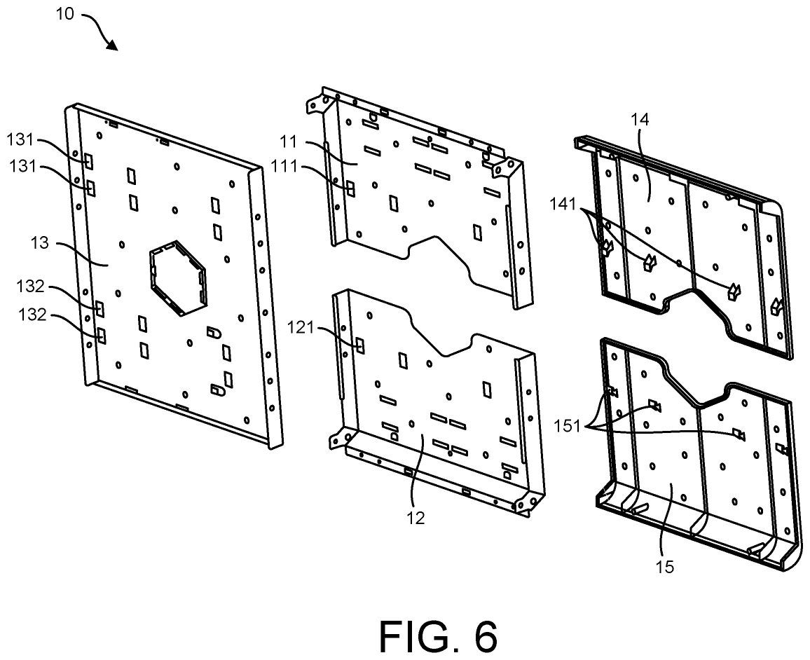

Referring to FIGS. 5 and 6, the adjustable front plate assembly 10 includes a first front panel 11, a second front panel 12, a front connecting plate 13, a first protective cover 14, and a second protective cover 15. The first front panel 11 and the second front panel 12 are disposed vertically and are vertically adjustable relative to each other to change the overall height of the adjustable front plate assembly 10. The first front panel 11 is connected to an upper portion of a front connecting plate 13 and the second front panel 12 is connected to a lower portion of the front connecting plate 13. As explained in greater detail below, height adjustment is accomplished by incorporating multiple sets of adjusting holes 131, 132 on the front connecting plate 13 as well as at least one set of connecting holes 111 located on the first front panel 11 and at least one set of adjusting holes 121 located on second front panel 12.

The connecting holes 111 of the first front panel 11 correspond to the adjusting holes 131 of the upper portion of the front connecting plate 13. The first front protective cover 14 is mounted on the front side of the first front panel 11. In one embodiment, first front protective cover 14 includes flanges 141, 151. The flanges 141, 151 are extensions or protrusions on the back of the protective covers 14, 15 or the panels 11, 12. The first front panel 11, and the front connecting plate 13 are connected and aligned by passing first flanges 141 through the connecting holes 111 and snapping first flanges 141 into one of the sets of adjusting holes 131 of the upper portion of the connecting plate 13.

The adjusting holes 121 of the second front panel 12 correspond to the adjusting holes 132 of the lower portion of the front connecting plate 13. The second front protective cover 15 is mounted on the front side of the second front panel 12. In one embodiment, second front protective cover 15 includes flanges 151. The second front panel 12, and the front connecting plate 13 are connected and aligned by passing second flanges 151 through the adjusting holes 121 and snapping second flanges 151 into one of the sets of adjusting holes 132 of the lower portion of the front connecting plate 13.

While flanges 141, 151 are shown, it is contemplated that other fastening means may be used to accomplish the same objectives. Other suitable fastening means include, but are not limited to, screws, snaps, rivets, dowels, etc.

The multiple configurations provided by the alignment of different sets of connecting holes 111 and adjusting holes 121 dictate the overall height of the front plate assembly 10. As will be described in further detail below, the rear plate assembly 20 and the side plate assemblies 30 work similarly. Thus, all four sides of the computer hardware case 1 are capable of being fastened at different heights which results in a computer hardware case 1 that is capable of being constructed with different heights, which, advantageously, results in a computer hardware case having any sized internal cavity space in order to accommodate a variety of hardware components therein.

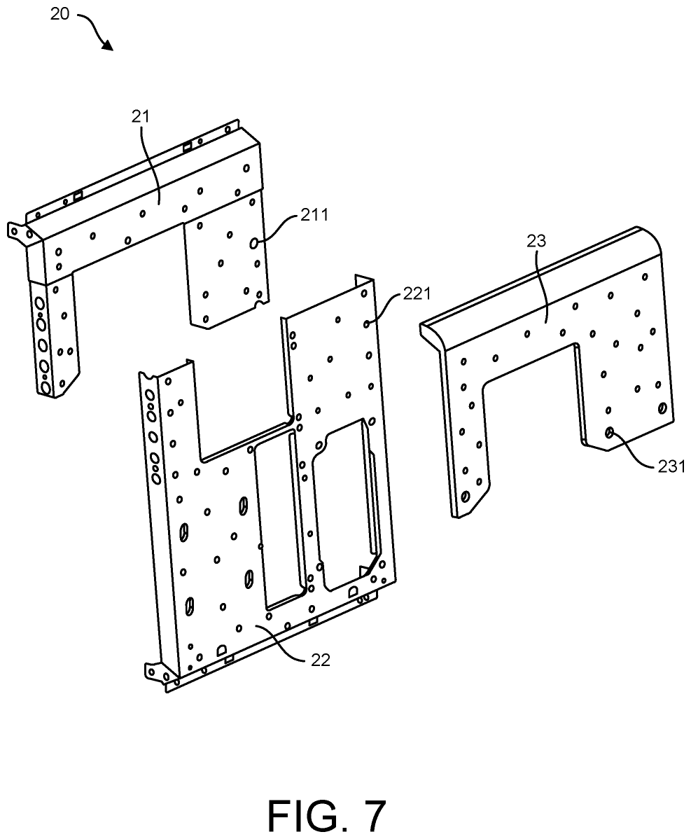

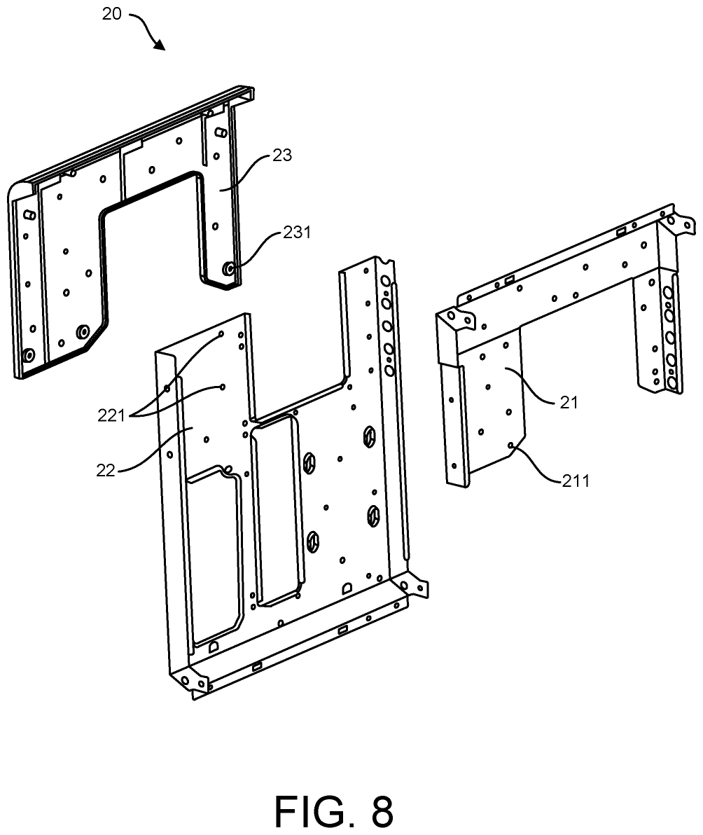

Referring to FIGS. 7 and 8, adjustable rear plate assembly 20 can be seen. Adjustable rear plate assembly 20 includes a first rear panel 21 and a second rear panel 22. The first rear panel 21 and the second rear panel 22 are vertically adjustable relative to each other to change the overall height of the adjustable rear plate assembly 20. The second rear panel 22 has at least two sets of adjusting holes 221 arranged vertically, and configured to correspond to a set of connecting holes 211 on the first rear panel 21. The connecting holes 211 of the first rear panel 21 may be aligned with and fastened to either set of adjusting holes 221 depending on the desired height of the hardware case 1.

In one embodiment, rear plate assembly 20 may be provided with rear protective cover 23. The rear protective cover 23 is provided with protective cover holes 231 to align with the connecting holes 211 of the first rear panel 21.

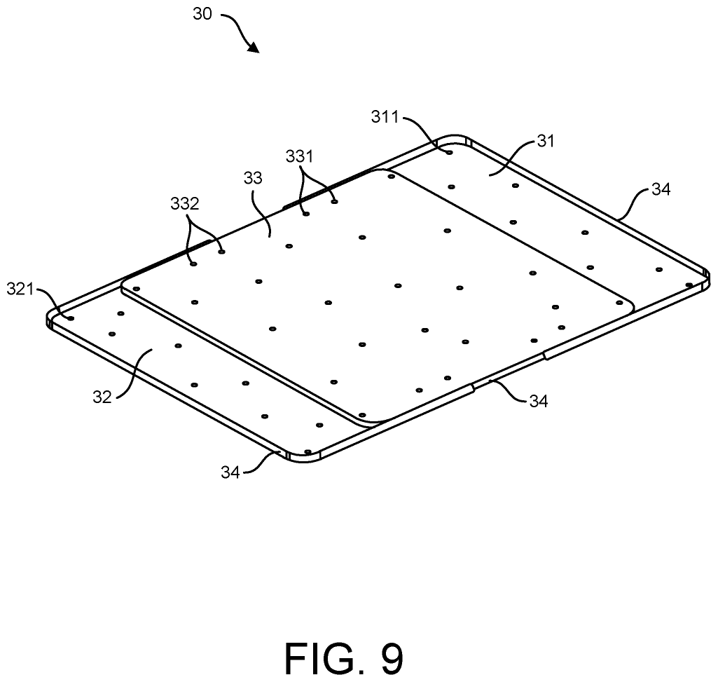

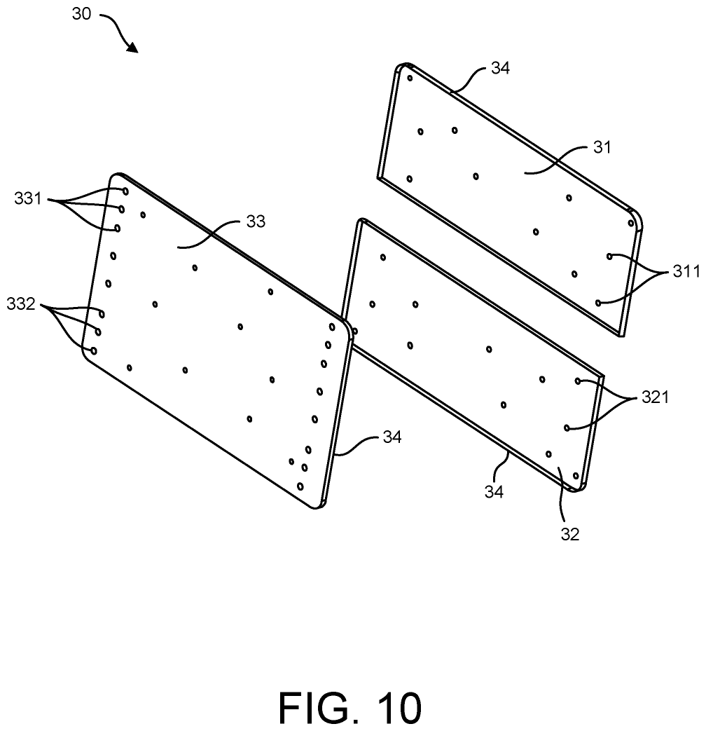

Referring to FIGS. 9 and 10, the adjustable side plate assemblies 30 can be seen. Side plate assemblies 30 each include a first side panel 31 and a second side panel 32 disposed vertically. The first side panel 31 and the second side panel 32 are vertically adjustable relative to each other to change the overall height of the adjustable side plate assemblies 30. The first side panel 31 is connected to the upper portion of a side connecting plate 33 and the second side panel 32 is connected to the lower portion of the side connecting plate 33.

The upper portion of the side connecting plate 33 has at least two sets of adjusting holes 331 arranged vertically. The first side panel 31 is provided with a set of connecting holes 311. As the first side panel 31 is adjusted up and down on the side connecting plate 33, the connecting holes 311 of the first side panel 31 align with and are fastened to the adjusting holes 331 of the upper portion of the side connecting plate 33.

The lower portion of the side connecting plate 33 has at least two sets of adjusting holes 332 arranged vertically. The second side panel 32 is provided with a set of connecting holes 321. As the second side panel 32 is adjusted up and down on the side connecting plate 33, the connecting holes 321 of the second side panel 32 align with and fasten to the adjusting holes 332 of the side connecting plate 33.

In some embodiments, the edges 34 of the first side panel 31 and the second side panel 32 are curved and the edges 34 of the side connecting plate 33 are also curved. The bent edges 34 can enhance the overall structural strength of the first side panel 31, the second side panel 32, and the side connecting plate 33 and provide stability when the first side panel 31, the second side panel 32, and the side connecting plate 33 are assembled. In embodiments having bent edges 34, the side connecting plate 33 fits within the first side panel 31 and the second side panel 32, so that the edge 34 of the side connecting plate 33 is located on the inner side of the edges 34 of the first side panel 31 and second side panel 32.

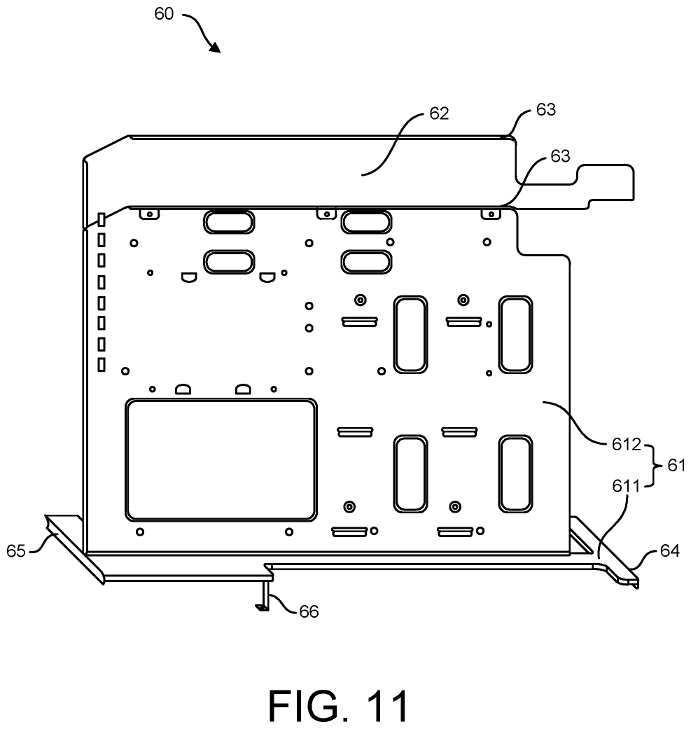

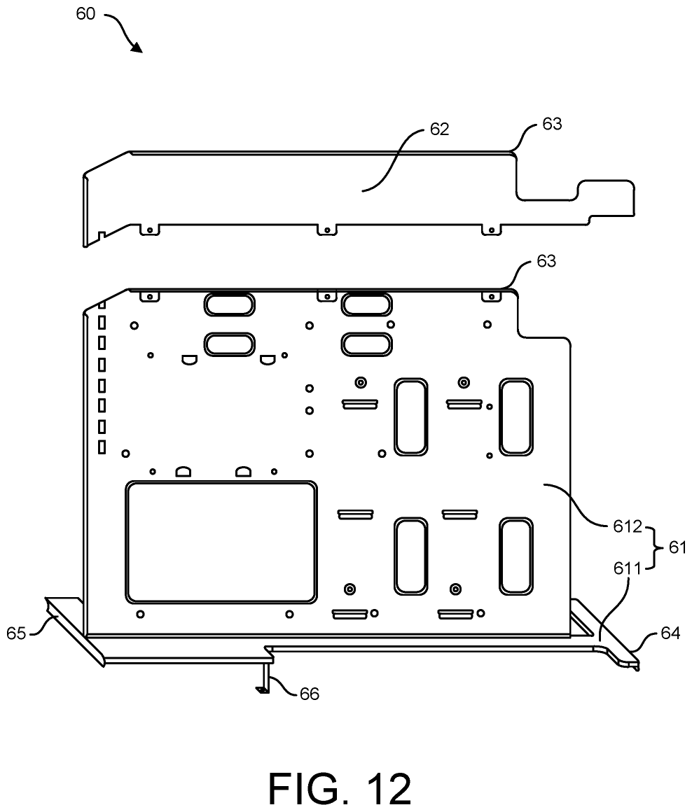

Referring to FIGS. 11 and 12, in one embodiment, the interior of the main body of the chassis includes an inner frame assembly 60. The inner frame assembly 60 includes an inner frame 61 and an extension 62. The inner frame assembly 60 provides a surface upon which computer hardware components may be attached. The inner frame assembly 60 also provides additional structural supports to maintain the internal cavity of the computer hardware case 1. The inner frame 61 includes a bottom connecting plate 611 and a securing plate 612 substantially perpendicularly connected to the bottom connecting plate 611. The front 64 and rear ends 65 of the bottom connecting plate 611 are connected, respectively, to the front plate assembly 10 and the rear plate assembly 20. The bottom connecting plate 611 is connected to the bottom plate 50 through a downwardly extending piece 66 so that the bottom connecting plate 611 and the bottom plate 50 maintain a vertical gap therebetween.

In some embodiments, the inner frame assembly 60 may only include the securing plate 612. The securing plate 612 may be affixed at one end to the bottom plate 50 and at the opposite end to the top plate 40, resulting in a horizontal orientation. In alternative embodiments, the securing plate may be secured to each side plate assembly 30, resulting in a horizontal orientation.

The extension 62 is detachably connected to the top of the securing plate 612. The top of the securing plate 612 and the top of the extension inner frame 62 are provided with a connecting portion 63 for connecting with the top plate 40. In a collapsed configuration, the top plate connecting portion 63 of the inner frame 61 is connected to the top plate 40. In an expanded configuration, the extension 62 is connected to the top of the securing plate 612, and the top plate connecting portion 63 of the extension 62 is connected to the top plate 40.

In one embodiment, the first side panel 31, the second side panel 32, the first front panel 11, the second front panel 12, the first rear panel 21, the second rear panel 22, the front connecting plate 13, and the side connecting plates 33 are also mesh plates. The mesh plates allow cold air inflow and hot air to be discharged from different directions to improve heat dissipation.

In one embodiment, dust screens are disposed on the top plate 40 and the bottom plate 50. The top plate 40 is recessed within a mounting slot for the dust screen, and the inner wall of the mounting slot is connected with a magnetic component.

In one embodiment, the bottom plate includes foot pads.

In one embodiment, the adjustable computer hardware case 1 includes an adjustable or reconfigurable input/output panel. The reconfigurable input/output panel may include various USB input/outputs or reset button or any other input or output for a user's specific needs.

All parts of the adjustable computer hardware case 1 may be made of any suitably rigid material to protect and support a variety of computer hardware components. In some non-limiting exemplary embodiments, the adjustable computer hardware case 1 is made of plastic, metal, alloy, or other similar material (e.g., acrylonitrile butadiene styrene or aluminum).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. An adjustable computer hardware case, the hardware case comprising:
a top plate, a bottom plate, a front plate assembly, a rear plate assembly, and opposing side plate assemblies;
the front plate assembly, the rear plate assembly, and the opposing side plate assemblies each comprised of an upper panel and a lower panel; and
the respective upper and lower panels having multiple connection positions such that the hardware case can be adjusted to different heights depending upon the relative connection positions of the respective upper and lower panels.

2. The adjustable computer hardware case of claim 1, further comprising the upper panels each having a set of connecting holes, the lower panels each having at least two sets of corresponding adjusting holes, wherein the respective upper and lower panels are connected to form the computer hardware case having variable height by aligning the set of connecting holes to one of the sets of corresponding adjusting holes.

3. The adjustable computer hardware case of claim 1, wherein the front plate assembly and the opposing side plate assemblies each include a connecting plate, each connecting plate comprising:
an upper portion with at least two sets of upper panel adjusting holes; and
a lower portion with at least two sets of lower panel adjusting holes, wherein
a set of the at least two sets of upper panel adjusting holes of the connecting plates are configured to be aligned with a set of connecting holes in the respective upper panel of the front plate assembly and the side plate assembly, and a set of the at least two sets of lower panel adjusting holes are configured to be aligned with a set of the adjusting holes in the lower panel of the front plate assembly and the side plate assembly, resulting in the computer hardware case being adjustable to variable heights.

4. The adjustable computer hardware case of claim 1, further comprising an inner frame having a top and a bottom, wherein the bottom of the inner frame is affixed to the bottom plate of the computer hardware case extending upward within a cavity of the computer hardware case.

5. The adjustable computer hardware case of claim 4, wherein the top of the inner frame is affixed to the top plate of the computer hardware case.

6. The adjustable computer hardware case of claim 4, further comprising:
an inner frame extension for use in an expanded configuration of the adjustable computer hardware case, wherein the inner frame extension has a top and a bottom, the bottom of the inner frame extension affixed to the top of the inner frame, and the top of the inner frame extension is affixed to the top plate of the computer hardware case.

7. The adjustable computer hardware case of claim 1, further comprising an inner frame wherein a side of the inner frame is affixed to one of the side plate assemblies of the computer hardware case extending horizontally into a cavity of the computer hardware case.

8. An adjustable computer hardware case, comprising:
a top plate;
a bottom plate;
an adjustable front plate assembly comprising a first front panel and a second front panel, the first front panel and the second front panel being vertically adjustable relative to each other to change the overall height of the adjustable front plate assembly;
an adjustable rear plate assembly comprising a first rear panel and a second rear panel, the first rear panel and the second rear panel being vertically adjustable relative to each other to change the overall height of the adjustable rear plate assembly; and
two adjustable side plate assemblies, each of the two adjustable side plate assemblies including first side panels and second side panels, the first side panels and the second side panels being vertically adjustable relative to each other to change the overall height of the adjustable side plate assemblies;
the adjustable front plate assembly situated between left and right ends of the two adjustable side plate assemblies, and the adjustable rear plate assembly situated between left and right ends of the two adjustable side plate assemblies, the top plate situated between tops of the adjustable front plate assembly, the adjustable rear plate assembly, and the two adjustable side plate assemblies, and the bottom plate situated between bottoms of the adjustable front plate assembly, the adjustable rear plate assembly, and the two adjustable side plate assemblies.

9. The adjustable computer hardware case of claim 8, further comprising:
a front connecting plate, wherein the first front panel is connected to an upper portion of the front connecting plate, and the second front panel is connected to a lower portion of the front connecting plate.

10. The adjustable computer hardware case of claim 9, wherein the upper portion of the front connecting plate has at least two sets of adjusting holes arranged vertically and corresponding to a set of connecting holes on the first front panel;
the first front panel and the upper portion of the front connecting plate are connected by fastening the set of connecting holes of the first front panel with one of the sets of adjusting holes of the upper portion of the front connecting plate;
the lower portion of the front connecting plate has at least two sets of adjusting holes arranged vertically and corresponding to a set of connecting holes on the second front panel; and
the second front panel and the lower portion of the front connecting plate are connected by fastening the set of connecting holes of the first front panel with one of the sets of adjusting holes of the lower portion of the front connecting plate.

11. The adjustable computer hardware case of claim 8, wherein the first side panels and second side panels are connected with side connecting plates;
the first side panels are connected to upper portions of the respective side connecting plates; and
the second side panels are connected to lower portions of the respective side connecting plates.

12. The adjustable computer hardware case of claim 11, wherein the upper portions of the side connecting plates have at least two sets of adjusting holes arranged vertically and corresponding to a set of connecting holes on the first side panels;
the first side panels and the upper portions of the side connecting plates are connected by fastening the sets of connecting holes of the first side panels with one of the sets of adjusting holes of the upper portions of the side connecting plates;
the lower portions of the side connecting plates have at least two sets of adjusting holes arranged vertically and corresponding to a set of connecting holes on the second side panels of the side plate assemblies; and
the second side panels and the lower portions of the side connecting plates are connected by fastening the sets of connecting holes of the second side panels with one of the sets of adjusting holes of the lower portions of the side connecting plates.

13. The adjustable computer hardware case of claim 8, further comprising:
the second rear panel having at least two sets of adjusting holes arranged vertically and corresponding to a set of connecting holes of the first rear panel; and
the first rear panel and second rear panel are connected by fastening the set of connecting holes with one of the sets of adjusting holes of the second rear panel.

14. The adjustable computer hardware case of claim 8, further comprising an inner frame, one end of the inner frame affixed to the bottom plate and an opposite end of the inner frame affixed to the top plate.

15. The adjustable computer hardware case of claim 14, further comprising an inner frame extension for use in an expanded configuration of the adjustable computer hardware case, wherein one end of the inner frame extension is affixed to a top of the inner frame, and an opposite end of the inner frame is affixed to the top plate.

16. The adjustable computer hardware case of claim 8, further comprising an inner frame, one end of the inner frame affixed to the adjustable side plate assemblies and an opposite end of the inner frame affixed to the other adjustable side plate assembly.

17. A method of adjusting the dimensions of a computer hardware case, the method comprising:
providing a front assembly, a rear assembly, and opposing side assemblies, each assembly having a top panel and a bottom panel, each top panel having at least two sets of connecting holes, each bottom panel having at least two sets of corresponding holes;
aligning one set of connecting holes with one set of corresponding holes;
securing each set of connecting holes with the aligned set of corresponding holes to maintain the panels in their adjusted configuration.
